(19) United States
(12) Patent Application Publication
(10) Pub. No.: US 2024/0390838 A1
(43) Pub. Date: Nov. 28, 2024

(54) A system for reducing ammonium bisulfate blockage in air preheaters of coal-fired power plants

(71) Applicant: Qinghua Huang, Beijing (CN)

(72) Inventor: Qinghua Huang, Beijing (CN)

(21) Appl. No.: 18/689,452

(22) PCT Filed: Sep. 15, 2022
(86) PCT No.: PCT/CN2022/000131

§ 371 Date: Mar. 6, 2024

(30) Foreign Application Priority Data
Sep. 15, 2021 (CN) 202111077628.8

(51) Int. Cl. B01D 53/10; B01D 53/86; F23L 15/00

(52) U.S. Cl. CPC B01D 53/10; B01D 53/8625; B01D 2253/11; B01D 2253/25; B01D 2257/302; B01D 2257/406; B01D 2258/0283; F23L 15/00

(57) ABSTRACT

The present invention discloses a system for reducing ammonium bisulfate blockage in air preheaters of coal-fired power plants, comprising at least one powder, at least one powder injection device, and at least one powder storage device; Under the action of power, the powder enters the powder injection device from the powder storage device, and is then sprayed into the flue between the SCR denitrification reactor and the air preheater. The powder can selectively adsorb the precursor ammonia gas and/or sulfur trioxide of ammonium bisulfate, thereby reducing the generation of ammonium bisulfate, removing the ammonium bisulfate that causes blockage of the air preheater from the source, and reducing the deposition of ammonium bisulfate and/or ash on the heating surface of the air preheater. It has the characteristics of simple process, low equipment cost, low price of powder used, and low construction and operation costs.

### CROSS REFERENCE TO RELATED APPLICATION

This patent document is a patent application, which claims priority and benefits of CHINA Patent Application No. 2021110776288, filed Sep. 15, 2021, the entire contents of which is incorporated herein by reference for all purposes.

### TECHNICAL FIELD

The present invention relates to a system for reducing ammonium bisulfate blockage in air preheaters of coal-fired power plants, belonging to the field of energy-saving and environmental protection of coal-fired power plant boilers.

### BACKGROUND

With the improvement of environmental standards and stricter environmental law enforcement in China, coal-fired power plants are pursuing ultra-high denitrification rates, often, it can lead to excessive use of denitration reducing agent ammonia, resulting in increasingly serious problems of air preheater blockage in coal-fired power plants.

Air preheater is a preheating equipment that improves boiler heat exchange performance and reduces heat loss. The function of an air preheater is to transfer the heat carried by the flue gas discharged from the tail flue of the boiler through the heat dissipation fins to the air before entering the boiler, preheating the air to a certain temperature. Air preheaters are commonly used in coal-fired power plant boilers and can be divided into two types: tube and box type and rotary type. Power plant boilers often use heating surface rotary preheaters. Taking a rotary air preheater as an example to illustrate the principle of an air preheater, it rotates slowly during operation, and the flue gas enters the flue gas side of the air preheater before being discharged. The heat carried by the flue gas is absorbed by the heat dissipation fins in the air preheater. Then, the air preheater rotates slowly, and the heat dissipation fins move to the air side, transferring the heat to the air before entering the boiler. As an important heat exchange equipment for boilers, the operation status of air preheaters directly affects the economy and safety of boilers. Currently, the vast majority of boiler air preheaters in China suffer from varying degrees of ash accumulation and blockage, especially after the operation of denitrification devices, the blockage and corrosion of air preheaters become more severe.

The removal of nitrogen oxides (NOx) from flue gas of coal-fired power plant boilers mainly adopts selective catalytic reduction (SCR) denitrification technology. After the SCR chemical reaction is completed, the excess reducing agent NH3 will react with sulfur trioxide (SO3) and nitrogen oxides (NOx) in the air preheater to produce ammonium bisulfate (NH4HSO4).

The main cause of blockage in the air preheater is the condensation and bonding of ammonium bisulfate (ABS) in the air preheater body. The melting point of ammonium bisulfate is 147° C. When the flue gas temperature is within the range of 150-230° C., as the flue gas temperature decreases, ammonium bisulfate transforms from a gaseous liquid to a solid state. Under certain conditions, ammonium bisulfate is a very viscous substance, which is prone to deposition on the heat exchange components of the air preheater. The hazards caused by the deposition of ammonium bisulfate on the heat exchange components of the air preheater include: (1) the formed scale is difficult to remove, which can easily block the air preheater, affect the safe operation of the equipment, increase the operating resistance of the air preheater, and increase the energy consumption of the air preheater; (2) Causing severe low-temperature corrosion of the air preheater and a significant increase in air leakage rate. The so-called air leakage of the air preheater refers to the air sent from the supply fan to the air preheater, which directly leaks into the tail flue gas without undergoing furnace combustion heat exchange. When the output of the induced draft fan remains unchanged, an increase in air leakage will inevitably result in insufficient air volume required for boiler combustion, and the presence of air leakage reduces the effectiveness of the air preheater, causing a decrease in the temperature of the primary and secondary air, which has a significant impact on the normal combustion of coal powder and the normal operation of the powder making system, increasing the incomplete combustion loss of coal powder. At the same time, it greatly weakens the intensity of radiation heat transfer in the furnace, reducing the heat transfer efficiency of the boiler. Unburned air directly enters the flue, increasing the flow rate of flue gas to maintain the stability of negative pressure in the boiler furnace. It is necessary to increase the output of the induced draft fan, thereby increasing the consumption of electrical energy.

Among the existing technical solutions related to reducing ammonium bisulfate blockage in air preheaters of coal-fired power plants, patent number CN204853539U has disclosed a system that utilizes hot air recirculation to remove ammonium bisulfate from air preheaters. Although this technology involves the removal of ammonium bisulfate from air preheaters, it cannot address the problem of ammonium bisulfate blockage in air preheaters from the source; Patent number CN208124351U discloses an anti clogging and cleaning system for a rotary air preheater. Although it involves preventing clogging of heat exchange elements in the air preheater and the deposition of ammonium bisulfate, this technology cannot address the problem of ammonium bisulfate clogging in the air preheater from the source. The above two technical solutions both consider measures from the perspective of the air preheater to clean the ammonium bisulfate that has been deposited on the air preheater to solve the problem. They do not involve reducing the amount of ammonium bisulfate that is easily deposited upon arrival in the air preheater, but rather addressing the problem of ammonium bisulfate blockage in the air preheater from the source.

Patents CN204853539U and CN208124351U are respectively used to reduce the blockage problem of ammonium bisulfate in the air preheater. CN204853539U uses high-temperature gas to continuously concentrate and sweep the cold end heat transfer elements in the boundary area between the smoke and air sides of the air preheater and the secondary air side, causing the ammonia hydrogen sulfate to be carried away from the heat transfer elements with the hot air; This belongs to the cleaning strategy after the deposition of ammonium bisulfate into the air preheater, rather than addressing the problem of ammonium bisulfate blockage in the air preheater from the source. CN208124351U uses a hot air injection device to blow hot air through the cold end heat exchange elements of the primary air chamber of the air preheater, achieving the cleaning of ash and hydrogen sulfate ammonia deposits in the heat exchange elements of the air preheater; It also belongs to the cleaning strategy after the deposition of ammonium bisulfate into the air preheater, and it is not to address the problem of ammonium bisulfate blockage in the air preheater from the source.

### SUMMARY

To solve the problem of ammonium bisulfate blockage in the air preheater of coal-fired power plants, the present invention proposes a system for reducing ammonium bisulfate blockage in the air preheater of coal-fired power plants. The system sprays selective adsorption precursor ammonia and/or sulfur trioxide powder (which can selectively adsorb precursor ammonia and/or sulfur trioxide of ammonium bisulfate) into the flue between the SCR denitrification reactor and the air preheater, So as to reduce the generation of ammonium bisulfate, the precursor of ammonium bisulfate adsorbed with ammonia gas and/or sulfur trioxide is not easily deposited on the air preheater, and the ammonium bisulfate that causes blockage of the air preheater is removed from the source; In addition, the powder used can also promote the nucleation of fine particle ash and the formation of large particle ash. Large particle ash has high kinetic energy and is not easy to deposit, reducing the deposition of hydrogen sulfate ammonia and/or ash on the heating surface of the air preheater. The system has the characteristics of simple process, low equipment cost, low powder price, and low construction and operation costs. The main purpose of the present invention is to solve the problem of blockage of air preheaters in coal-fired power plants due to ammonium bisulfate.

To achieve the above objectives, the technical solution adopted by the present invention is a system for reducing the blockage of ammonium bisulfate in the air preheater of a coal-fired power plant. The system includes at least one type of powder, at least one set of powder injection device, and at least one set of powder storage device; The powder storage device is connected to the corresponding powder spraying device through a pipeline; One side of the powder injection device is connected to the powder storage device, and the other side of the powder injection device is inserted into the flue between the SCR denitrification reactor and the air preheater; Under the action of power, the powder enters the powder injection device from the powder storage device, and then is sprayed into the flue between the SCR denitrification reactor and the air preheater from the injection device. The powder can selectively adsorb the precursor ammonia gas and/or sulfur trioxide of ammonium bisulfate.

Furthermore, the powder can selectively adsorb precursor ammonia gas and/or sulfur trioxide of ammonium bisulfate; This powder is made from the mass fraction of the following raw materials:
Diatomaceous earth (0-12%), vermiculite (0-10%), Ca3(PO4)2 (0.5-5%), CuSO4 (0˜2%), H3PO4 (1-5%), fly ash (70-95%), and active clay (0-5%).

Furthermore, the powder storage device comprises a powder storage tank, a powder weighing unit, and a powder pushing unit; The powder weighing unit is connected to the powder storage tank on one side of the pipeline, and to the powder pushing unit on the other side; The powder pushing unit is connected to the powder source inlet of the injection device through the other side of the pipeline.

Furthermore, the powder injection device comprises at least one fan, at least one injection device, and at least one nozzle (or nozzle); Connect the outlet of the fan to the inlet of the air source of the injection device; The powder source inlet of the injection device is connected to the powder pushing unit through a pipeline; The outlet of the injection device is connected to the nozzle through a pipeline; The nozzle is located in the flue between the SCR denitrification reactor and the air preheater; The inlet gas source of the fan is the flue gas between the SCR denitrification reactor and the nozzle, the flue gas between the air preheater and the nozzle, the flue gas between the air preheater and the dust removal device, and the flue gas, primary air, secondary air, or air between the dust removal device and the desulfurization device.

Furthermore, the powder injection device comprises at least one nozzle, which is located in the flue between the SCR denitrification reactor and the air preheater. The number and arrangement of nozzles are determined by the results of flow field simulation calculations;

Furthermore, in order for the powder sprayed into the flue from the nozzle to be evenly distributed in the flue, guide vanes, turbulence or other structures of different shapes are installed upstream or downstream of the nozzle in the flue;

Furthermore, the quality of the powder injected into the flue is determined by the operating conditions of the boiler, the ammonia concentration in the flue between the SCR denitrification reactor (8) and the air preheater (9), and the concentration of sulfur trioxide;

Furthermore, the amount of air source at the inlet of fan (3) is determined based on the mass of powder sprayed into the flue;

Furthermore, the powder passes through the powder weighing unit (5), powder pushing unit (6), and nozzle (1) respectively from the powder storage tank (4), and is sprayed into the flue between the SCR denitrification reactor (8) and the air preheater (9). The powder selectively adsorbs ammonia and/or sulfur trioxide in the flue gas, thereby reducing the generation of ammonium bisulfate. At the same time, the powder can nucleate with fine particle ash to form large particle ash, which has high kinetic energy and is not easy to deposit, thereby reducing the deposition of ammonium bisulfate and/or ash on the heating surface of the air preheater.

Furthermore, the working principle of a system for reducing ammonium bisulfate blockage in air preheaters of coal-fired power plants is as follows:

By spraying selective adsorbed precursor ammonia gas and/or sulfur trioxide powder into the flue between the SCR denitrification reactor and the air preheater, the generation of ammonium bisulfate is reduced. The precursor ammonia gas and/or sulfur trioxide powder adsorbed on ammonium bisulfate are also less likely to deposit on the air preheater, and the ammonium bisulfate causing blockage in the air preheater is removed from the source, In addition, the powder used can also promote the nucleation of fine particle ash and the formation of large particle ash. Large particle ash has high kinetic energy and is not easy to deposit, reducing the deposition of hydrogen sulfate ammonia and/or ash on the heating surface of the air preheater.

Compared with existing technology, the present invention has the following beneficial effects.

The present invention proposes a system for reducing ammonium bisulfate blockage in air preheaters of coal-fired power plants. The system sprays a powder that can selectively adsorb precursor ammonia gas and/or sulfur trioxide of ammonium bisulfate into the flue between the SCR denitrification reactor and the air preheater, thereby reducing the generation of ammonium bisulfate and removing the ammonium bisulfate that causes blockage in the air preheater from the source. In addition, the powder used can promote the nucleation of fine particle ash to form large particle ash, which has high kinetic energy and is not easy to deposit, reducing the deposition of ammonium bisulfate and/or ash on the heating surface of the air preheater. The system has the characteristics of simple process, low equipment cost, low powder price, and low construction and operation costs.

### DESCRIPTION

### BRIEF DESCRIPTION OF THE DRAWINGS

Certain objectives, features, and advantages of the disclosed technology are illustrated by the following detailed description with reference to the accompanying drawings.

FIG. 1 is a schematic diagram of the system structure used to reduce ammonium bisulfate blockage in the air preheater of coal-fired power plants.

FIG. 2 is a schematic diagram of the nozzle layout.

In the figure: 1. nozzle (or nozzle), 2. injection device, 3. fan, 4. powder storage tank, 5. powder weighing unit, 6. powder pushing unit, 7. pipeline, 8. SCR denitrification reactor, 9. air preheater, 10. flue, 11. dust removal device, 12. desulfurization device.

### DETAILED DESCRIPTION

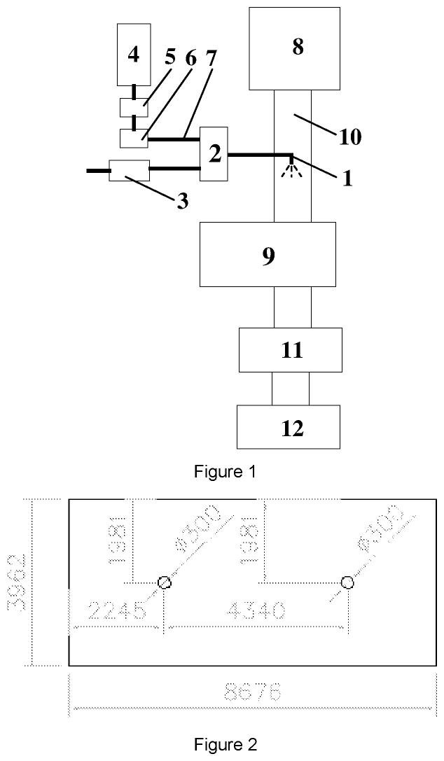

The system for reducing ammonium bisulfate blockage in the air preheater of a 600 MW coal-fired unit, under 50% BMCR conditions, has a flue gas volume of 116×104 Nm3/h on a wet basis, actual oxygen, and standard state, with a dust content of 32 g/Nm3. The flue gas temperature at the outlet of the SCR denitrification reactor is 355° C., and the cross-section of the upstream flue at the inlet of the air preheater is a rectangle of 8676 mm×3962 mm. As shown in FIG. 1, the nozzle (1) is arranged at a cross-sectional position 11m upstream of the inlet of the air preheater (9), as shown in FIG. 2, with a total of 2 nozzles (1) arranged; The inlet air source of fan (3) can come from air; The quality of the powder sprayed into the flue is determined by the operating conditions of the boiler, the ammonia concentration in the flue between the SCR denitrification reactor (8) and the air preheater (9), and the concentration of sulfur trioxide; The amount of air source at the inlet of fan (3) is determined based on the mass of powder sprayed into the flue; The powder passes through the powder weighing unit (5), powder pushing unit (6), and nozzle (1) from the powder storage tank (4), and is sprayed into the flue between the SCR denitrification reactor (8) and the air preheater (9). The powder selectively adsorbs ammonia and/or sulfur trioxide in the flue gas, thereby reducing the generation of ammonium bisulfate. At the same time, the powder can nucleate with fine particle ash to form large particle ash, which has high kinetic energy and is not easy to deposit, Thereby reducing the deposition of ammonium bisulfate and ash on the heating surface of the air preheater. After selectively adsorbing ammonia and/or sulfur trioxide in the flue gas, the powder passes through the air preheater (9) and is then mostly captured by the dust removal device (11), with a very small portion being captured by the desulfurization device (12).

Finally, it should be noted that the above embodiments are only intended to illustrate the present invention and not to limit the technical solutions described herein; Therefore, although this specification has provided a detailed description of the present invention with reference to the above embodiments, it should be understood by those skilled in the art that modifications or equivalent replacements can still be made to the present invention; All technical solutions and improvements that do not deviate from the spirit and scope of the present invention shall be covered within the scope of the claims of the present invention.

1. A system for reducing ammonium bisulfate blockage in air preheaters of coal-fired power plants, comprising:
Including at least one type of powder, at least one set of powder injection device, and at least one set of powder storage device; The powder storage device is connected to the corresponding powder spraying device through a pipeline; One side of the powder injection device is connected to the powder storage device, and the other side of the powder injection device is inserted into the flue between the SCR denitrification reactor and the air preheater; Under the action of power, the powder enters the powder injection device from the powder storage device, and then is sprayed into the flue between the SCR denitrification reactor and the air preheater from the injection device. The powder can selectively adsorb the precursor ammonia gas and/or sulfur trioxide of ammonium bisulfate.

2. A system for reducing ammonium bisulfate blockage in air preheaters of coal-fired power plants according to claim 1, characterized in that:
The powder can selectively adsorb precursor ammonia gas and/or sulfur trioxide of ammonium bisulfate; This powder is made from the mass fraction of the following raw materials:
Diatomaceous earth (0-12%), vermiculite (0-10%), Ca3(PO4)2 (0.5-5%), CuSO4 (0˜2%), H3PO4 (1-5%), fly ash (70-95%), and active clay (0-5%).

3. A system for reducing ammonium bisulfate blockage in air preheaters of coal-fired power plants according to claim 1, characterized in that:
The powder storage device includes a powder storage tank, a powder weighing unit, and a powder pushing unit; The powder weighing unit is connected to the powder storage tank on one side of the pipeline, and to the powder pushing unit on the other side; The powder pushing unit is connected to the powder source inlet of the injection device through the other side of the pipeline.

4. A system for reducing ammonium bisulfate blockage in air preheaters of coal-fired power plants according to claim 3, characterized in that:
The powder passes through the powder weighing unit (5), powder pushing unit (6), and nozzle (1) from the powder storage tank (4), and is sprayed into the flue between the SCR denitrification reactor (8) and the air preheater (9). The powder selectively adsorbs ammonia and/or sulfur trioxide in the flue gas, reducing the generation of ammonium bisulfate. The powder nucleates with fine particle ash to form particle ash, reducing the deposition of ammonium bisulfate and/or ash on the heating surface of the air preheater; After selectively adsorbing ammonia and/or sulfur trioxide from the flue gas, the powder passes through an air preheater (9) and is partially captured by a dust removal device (11), while a portion enters a desulfurization device (12) for capture.

5. A system for reducing ammonium bisulfate blockage in air preheaters of coal-fired power plants according to claim 1, characterized in that:
The powder injection device includes at least one fan, at least one injection device, and at least one nozzle; Connect the fan outlet to the inlet of the air source of the injection device; The powder source inlet of the injection device is connected to the powder pushing unit through a pipeline; The outlet of the injection device is connected to the nozzle through a pipeline; The nozzle is located in the flue between the SCR denitrification reactor and the air preheater; The inlet air source of the fan can come from air, smoke in the flue between the SCR denitrification reactor and the nozzle, smoke in the flue between the air preheater and the nozzle, smoke in the flue between the air preheater and the dust removal device, smoke in the flue between the dust removal device and the desulfurization device, primary or secondary air.

6. A system for reducing ammonium bisulfate blockage in air preheaters of coal-fired power plants according to claim 1, characterized in that:
The powder injection device includes at least one nozzle, which is located in the flue between the SCR denitrification reactor and the air preheater. The number and arrangement of nozzles are determined by the results of flow field simulation calculations.

7. A system for reducing ammonium bisulfate blockage in air preheaters of coal-fired power plants according to claim 1, characterized in that:
Install diversion and turbulence structures upstream or downstream of the nozzle in the flue.

8. A system for reducing ammonium bisulfate blockage in air preheaters of coal-fired power plants according to claim 1, characterized in that:
The quality of the powder sprayed into the flue is determined by the operating conditions of the boiler, the ammonia concentration in the flue between the SCR denitrification reactor (8) and the air preheater (9), and the concentration of sulfur trioxide.

9. A system for reducing ammonium bisulfate blockage in air preheaters of coal-fired power plants according to claim 1, characterized in that:
The amount of air source at the inlet of fan (3) is determined based on the quality of the powder sprayed into the flue.
